(19) United States
(12) Patent Application Publication
(10) Pub. No.: US 2005/0041015 A1
(43) Pub. Date: Feb. 24, 2005

(54) Electronic device, information display method, and information display program

(75) Inventors: Takamasa Kohda, Tokyo (JP); Shinjiro Ishida, Tokyo (JP); Kazuo Hirose, Tokyo (JP); Shoichi Nagatomo, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/922,278

(22) Filed: Aug. 19, 2004

(30) Foreign Application Priority Data
Aug. 22, 2003 (JP) 2003-298118
Jul. 14, 2004 (JP) 2004-207408

(51) Int. Cl. G09G 5/00

(52) U.S. Cl. 345/156

(57) ABSTRACT

When a searching of an image file is indicated, a wireless telephone extracts image files and makes the image files to be icons, and displays the icons in a layout on a display unit. When a positional information acquiring indication is detected, the wireless telephone acquires self-positional information, centering on the acquired self-position, leaves only the image files to which the positional information are added, reads place name folders corresponding to the image files, and displays those in a layout. When one of the displayed icons is selected and a network connection indication is detected, the wireless telephone achieves a session with a map information service company, and transmits the self-positional information and the positional information which the selected image file includes, to the map information service company.

### CROSS-REFERENCE TO RELATED APPLICATIONS

This application is based upon and claims the benefit of priority from prior Japanese Patent Applications No. 2003-298118, filed Aug. 22, 2003; and No. 2004-207408, filed Jul. 14, 2004, the entire contents of both of which are incorporated herein by reference.

### BACKGROUND OF THE INVENTION

1. Field of the Invention

The present invention relates to an electronic device, an information display method, and an information display program.

2. Description of the Related Art

Conventionally, a system in which a photographed image and positional information of the position of photographing can be stored has been proposed. This system includes a navigation device and a digital camera which are wirelessly connected to each other. When a request for positional information is issued from the digital camera, the navigation device answers-back the positional information to the digital camera. In the digital camera, the answered-back positional information is stored. When the photographed image is written into a memory card, the positional information is also written into so as to be in a state of being corresponded to the image. Therefore, when the image is filed after being photographed, at which place the image was photographed is made clear, and the added value of the navigation device can be improved (refer to Japanese Patent KOKAI Publication No. 2003-32590).

However, in the prior art disclosed in this document, it goes no further than that the positional information is stored so as to be in a state of being corresponded to the image when a photographed image is stored in a memory card. Accordingly, even if the added value of the navigation device can be improved as described above, the added value of the image to which the positional information is provided as well cannot be improved. Moreover, the prior art has been not a technique of effectively utilizing an image file to which the positional information is provided.

Further, with respect to electronic devices which can carry out not only displaying images, but also displaying various information outdoors, even if a function of acquiring positional information is provided thereto, there has been no electronic device in which the usability is improved.

### BRIEF SUMMARY OF THE INVENTION

The present invention is directed to an electronic device, an information display method, and an information display program in which various information to which positional information are added can be effectively utilized.

According to an embodiment of the present invention, an electronic device comprises:
a storage unit which stores data along with date information of a day when the data is operated;
a storage managing unit which manages the data stored in the storage unit on the basis of the date information;
a first positional information acquiring unit which acquires positional information at the time of operating the data;
a storage control unit which stores the positional information acquired by the first positional information acquiring unit so as to correspond to the operated data in the storage unit;
a display unit;
a first indicating unit which indicates a list-display of the data stored in the storage unit;
a first display control unit which displays the data on the display unit in a layout based on the date information managed by the storage managing unit when the list-display is indicated by the first indicating unit;
a second indicating unit which indicates a list-display based on the positional information of the data stored in the storage unit; and
a second display control unit which displays the data on the display unit in a layout based on the positional information which have been made to correspond to respective data stored in the storage unit when the list-display is indicated by the second indicating unit.

According to another embodiment of the present invention, an information display method for an electronic device having a positional information acquiring unit, the method comprises:
a first storage step of storing and managing data on the basis of date information of a day when the data is operated;
a first positional information acquiring step of acquiring positional information by the positional information acquiring unit when the data is operated;
a second storage step of storing the positional information acquired in the first positional information acquiring step so as to be made to correspond to the operated data;
a first indicating step of indicating a list-display of data stored in a memory;
a first display control step of displaying the data in a layout based on the date information stored in the first storage step when the list-display is indicated by the first indicating step;
a second indicating step of indicating a list-display based on the positional information of the data stored in the memory; and
a second display control step of displaying the various data in a layout based on the positional information which have been made to correspond to the respective data stored in the memory when the list-display is indicated by the second indicating step.

According to another embodiment of the present invention, an information display program which causes a computer of an electronic device comprising a positional information acquiring unit executes:
a first storage function of storing and managing data on the basis of date information of a day when the data is operated;
a first positional information acquiring function of acquiring positional information by the positional information acquiring unit when the data is operated;
a second storage function of storing the positional information acquired in the first positional information acquiring step so as to be made to correspond to the operated data;
a first indicating function of indicating a list-display of data stored in a memory;
a first display control function of displaying the data in a layout based on the date information stored in the first storage step when the list-display is indicated by the first indicating step;
a second indicating function of indicating a list-display based on the positional information of the data stored in the memory; and
a second display control function of displaying the various data in a layout based on the positional information which have been made to correspond to the respective data stored in the memory when the list-display is indicated by the second indicating step.

According to another embodiment of the present invention, an electronic device comprises:
means for storing data along with date information of a day when the data is operated;
storage managing means for managing the data stored in the storing means on the basis of the date information;
means for acquiring positional information at the time of operating the data;
storage control means for storing the positional information acquired by the first positional information acquiring means so as to correspond to the operated data in the storing means;
means for displaying;
first indicating means for indicating a list-display of the data stored in the storing means;
first display control means for displaying the data on the displaying means in a layout based on the date information managed by the storage managing means when the list-display is indicated by the first indicating means;
second indicating means for indicating a list-display based on the positional information of the data stored in the storing means; and
second display control means for displaying the data on the displaying means in a layout based on the positional information which have been made to correspond to respective data stored in the storing means when the list-display is indicated by the second indicating means.

Additional objects and advantages of the present invention will be set forth in the description which follows, and in part will be obvious from the description, or may be learned by practice of the present invention.

The objects and advantages of the present invention may be realized and obtained by unit of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a configuration of an image transmitting/receiving system according to an embodiment of the present invention;

FIG. 2 is a block diagram showing details of a map information service company;

FIG. 3 is a diagram showing contents of a map database management table;

FIG. 4A is a front view of a wireless telephone in the present embodiment;

FIG. 4B is a rear view of the wireless telephone in the present embodiment;

FIG. 5 is a block diagram showing a configuration of the wireless telephone;

FIG. 6 is a conceptual illustration showing contents of various programs stored in a ROM 125;

FIG. 7 is a conceptual illustration showing a configuration of a memory area of a RAM 124;

FIG. 8 is a flowchart showing a processing procedure of the wireless telephone in a photographing mode in the present embodiment;

FIG. 9 is a diagram showing contents of a data folder management table 1242;

FIG. 10 is a flowchart showing a processing procedure of the wireless telephone in a stand-by state and a processing procedure in a managing server of the map information service company;

FIGS. 11A, 11B, 11C, and 11D are respectively display transition diagrams of the wireless telephone;

FIGS. 12A, 12B, 12C, and 12D are respectively data transition diagrams showing a processing procedure of the managing server;

FIG. 13 is a diagram showing storing contents of the data folder management table 1242 in a modified embodiment; and

FIGS. 14A and 14B are respectively display transition diagrams of the wireless telephone in a modified embodiment.

### DETAILED DESCRIPTION OF THE INVENTION

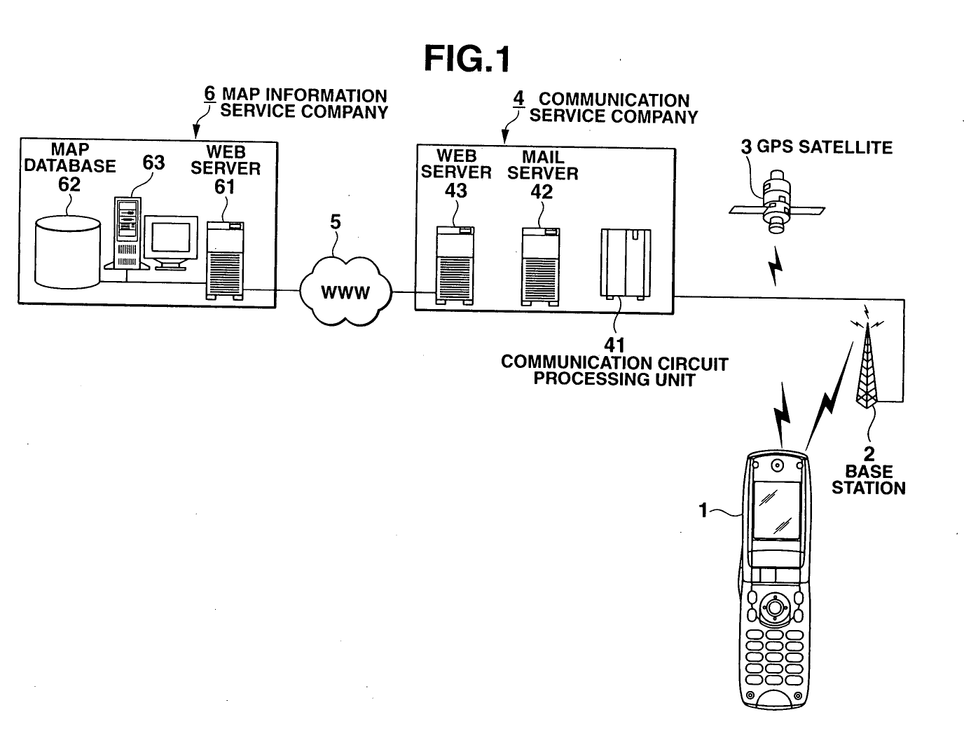

An embodiment of an electronic device, an information display method, and an information display program according to the present invention will now be described with reference to the accompanying drawings. FIG. 1 is a block diagram showing a configuration of a wireless communication system according to the present embodiment. A wireless telephone 1 functioning as an electronic device of the embodiment includes a telephone call function, a photographing function, an image transmitting/receiving function, and a positional information acquiring function of receiving positional information transmitted from a GPS satellite 3 (and as needed, compensating information transmitted from a wireless base station 2 as well). The wireless base station 2 connects the wireless telephone 1 to a communication service provider (including an Internet provider) 4 for which the wireless telephone 1 has been subscribed.

The communication service provider (including an Internet provider) 4 includes, as main services, in addition to a communication circuit processing unit 41 needed for the wireless telephone service which has been provided, a system (a Web server 43) for being connected to a WWW 5 which will be described later, a mail system (mail server 42), and further a function for connecting the wireless telephone 1 to the WWW 5 by using the wireless base station 2 as an AP (access point). A map information service company 6 includes a system for being connected to the WWW 5 (Web server 61), a managing server 63, and a map database 62.

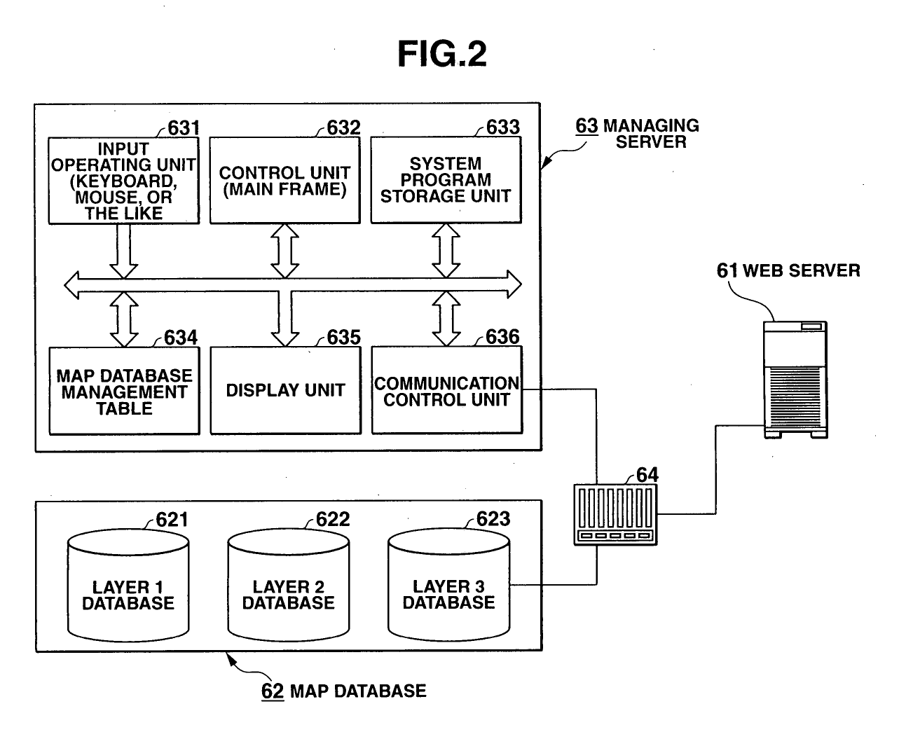

FIG. 2 is a block diagram showing the details of the map information service company 6. The Web server 61 is connected to the managing server 63 and the map database 62 via a hub 64. The managing server 63 includes an input operating unit (a keyboard, a mouse, or the like) 631, a control unit (main frame) 632, a system program storage unit 633, a map data management table 634 which will be described later, a display unit 635, and a communication control unit 636. Those are connected to each other through a system bus. The managing server 63 distributes the data (map information) stored in the data base 62 and carries out a downloading service with an admission fee for the wireless telephone 1 operated by a subscriber.

The map database 62 includes a layer-1 database 621, a layer-2 database 622, and a layer-3 database 623. Topographical data in the map data are stored in the layer-1 database 621, road data and route data in the map data are stored in the layer-2 database 622, and landmark (marker, index) data in the map data are stored in the layer-3 database 623. Accordingly, due to the topography data, the road and route data, and the landmark (marker, index) data which are stored in the respective databases 621, 622, and 623 being superposed on and synthesized each other, the map data having these topography, roads, routes, and landmarks (markers, indexes) is created. Further, because the landmarks are frequently changed due to buildings being removed or newly constructed, the map database 62 is configured so as to easily correspond to the changes in landmarks by updating only the landmark data in the layer-3 database 623.

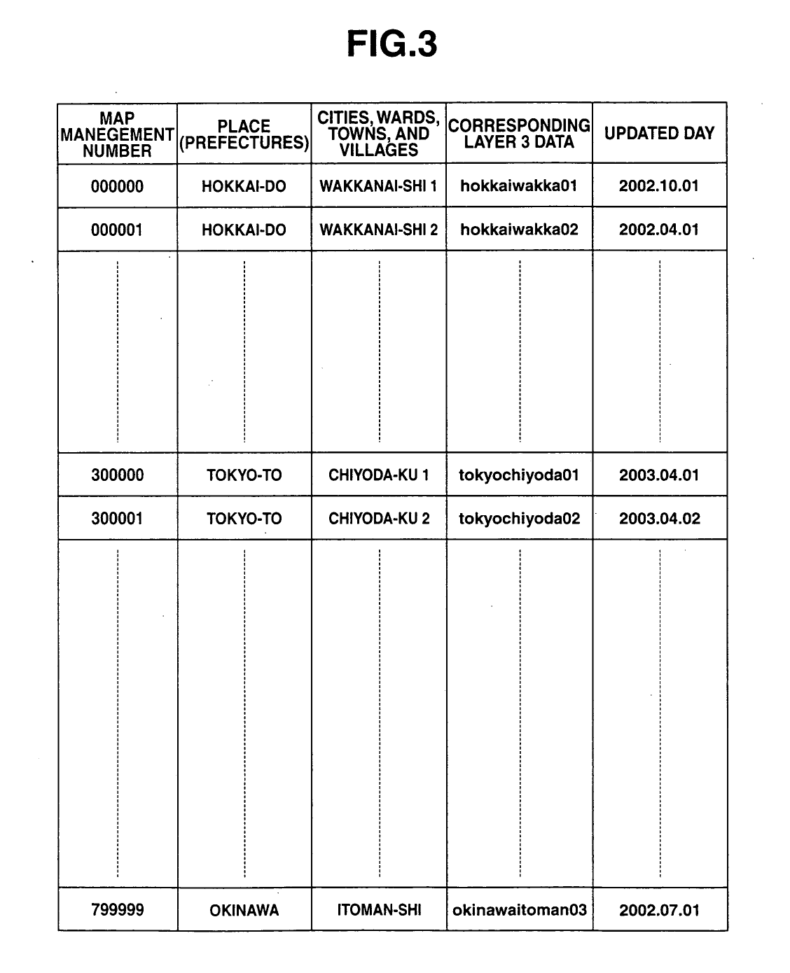

FIG. 3 shows a memory configuration of the map database management table 634. In the map database management table 634, “place (prefectures)”, “cities, wards, towns, and villages”, “corresponding layer-3 data”, and “updated day” are stored so as to respectively correspond to consecutive “map management numbers”. As will be described later, when the request from the wireless telephone 1 is received, the map database management table 634 specifies a corresponding map management number in the map on the basis of the positional information transmitted from the wireless telephone 1, and creates layer-4 data which will be described later by using the corresponding layer-3 data of the specified map management number.

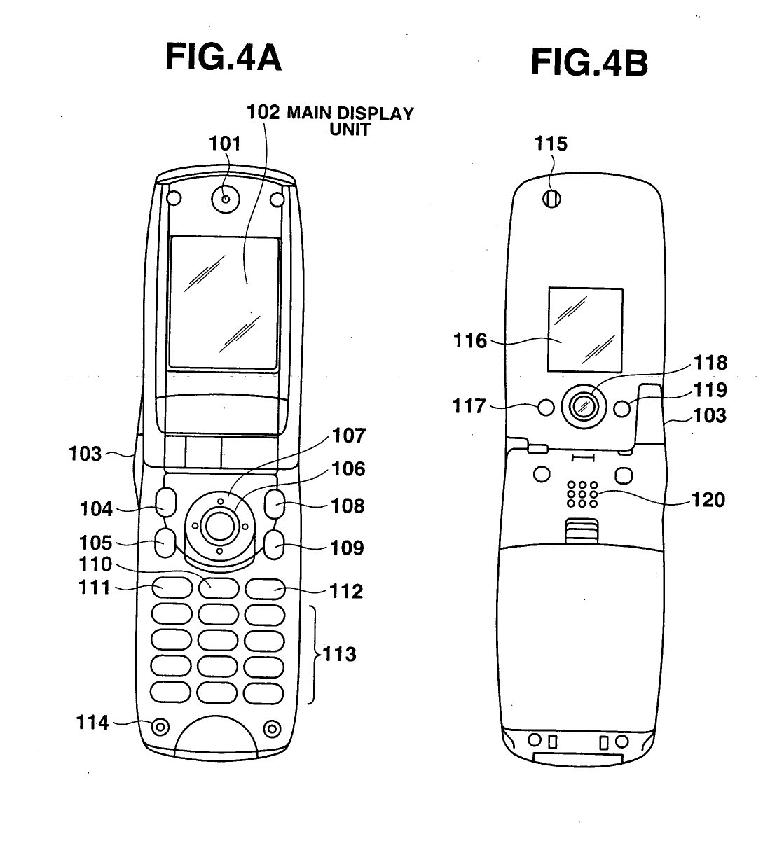

FIGS. 4A and 4B are outside drawings (open state: a front view and a rear view) of the wireless telephone 1 according to the present embodiment. The wireless telephone 1 includes a double-folded structure having a cover portion and a body portion. An antenna 103 is provided at a rear surface of the body portion, and is made to be telescopic. A speaker 101 is provided at a front surface side of the cover portion, and outputs audio. A main display unit 102 is a QVGA color liquid crystal, and is disposed at the substantially central portion on the front surface of the cover portion.

At a front surface of the body portion, a camera key 104, a mail key 105, a cross key 106, a decision key 107, an address key 108, a net connection key 109, a clear key 110, an on-hook key 111 and an off-hook key 112, and a ten key 113 are provided. The camera key 104 is operated when the operation mode of the wireless telephone 1 is shifted to a photographing mode and when an image pickup unit is started. The mail key 105 is operated when the operation mode of the wireless telephone 1 is shifted to a mail mode and when a mail program is loaded. The cross key 106 is operated at the time of moving a cursor and the time of focusing. The decision key 107 is operated at the time of deciding various modes and is operated as a shutter key at the time of photographing. The address key 108 is operated at the time of displaying address book data. The net connection key 109 is an operating key for being connected to a map information service company. The clear key 110 is a key for a cancellation indication. The ten key 113 is used for inputting characters and for inputting dials. Due to these keys 104 to 113 being operated with respect to predetermined combinations, a positional information acquiring indication, a indication of storing a photographed image, an indication of searching an image file with a position, and the like which are shown in flowcharts described later are carried out. Microphones 114 are provided at the lower portions of the body portion, and inputs audio at the time of a telephone call.

At the rear surface of the cover portion, a recording microphone 115, a sub-display unit 116 having a color liquid crystal, an indication LED 117 emitting light at the time of an incoming call, an image pickup lens 118, and a flashing LED 119 are disposed. An indication speaker 120 is disposed at the rear surface of the body portion. The indication speaker 120 notifies an incoming call or the like, and is disposed at the rear surface of the body portion in order for a notification sound to be heard even in a state in which the cover portion is closed onto the body portion.

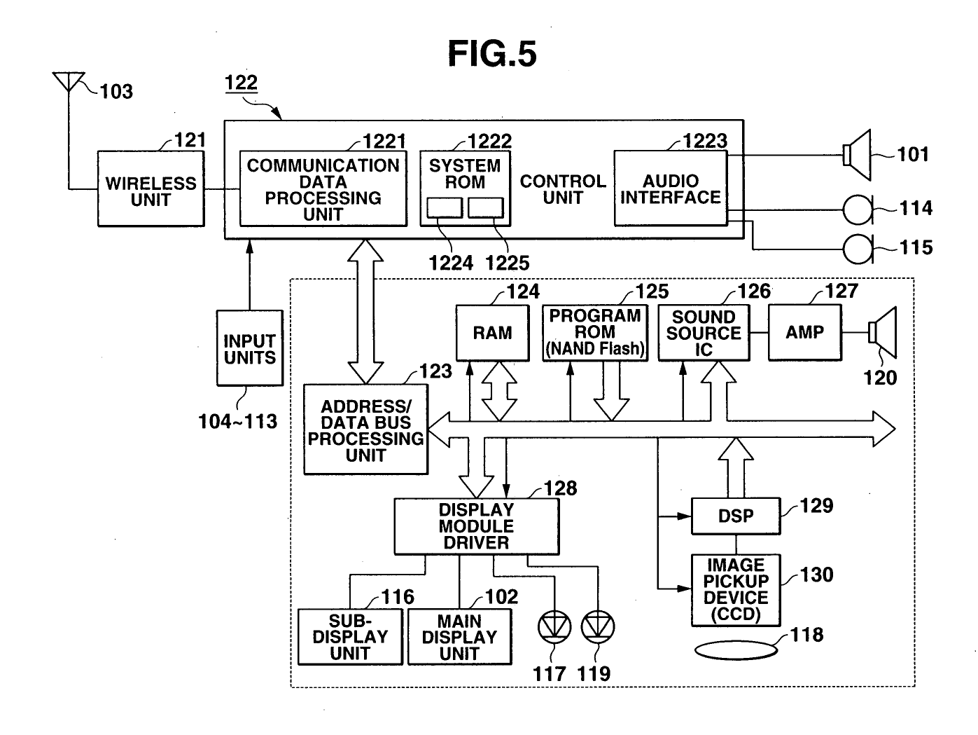

FIG. 5 is a block diagram showing a configuration of the wireless telephone 1. A wireless unit 121 is connected to the antenna 103, and carries out a modulation and a demodulation based on a PSK system, communication processing including terminal authentication processing based on a CDMA system, and signal receiving processing by plural GPS satellites 3. A control unit 122 controls the device, and carries out the WWW connection control, and includes a communication data processing unit 1221, a system ROM 1222, and an audio interface 1223, and as well as a clocking unit. The communication data processing unit 1221 includes a CELP system vocoder & audio decoding processing circuit, a packet data generating circuit, and a packet data reproducing circuit, and carries out data processing in accordance with a communication protocol.

A basic system such as an OS is stored in the system ROM 1222, and a subscriber information storage unit 1224 and a positional information arithmetic processing unit 1225 are provided in the system ROM 1222. The subscriber information storage unit 1224 stores terminal ID and subscriber ID which are needed for negotiations with the base station 2. The terminal ID is characteristic ID of the wireless telephone 1. In the positional information arithmetic processing unit 1225, an application for GPS processing is stored, and positional information (latitude/longitude information) are acquired by receiving the positional information from the GPS satellites 3 in accordance with this application. The audio interface 1223 carries out inputting/outputting of sound signals processed at the communication data processing unit 1221, and the speaker 101, the microphone 114, and the recording microphone 115 are connected to the audio interface 1223. The input unit includes the camera key 104 to the ten key 113, or the like.

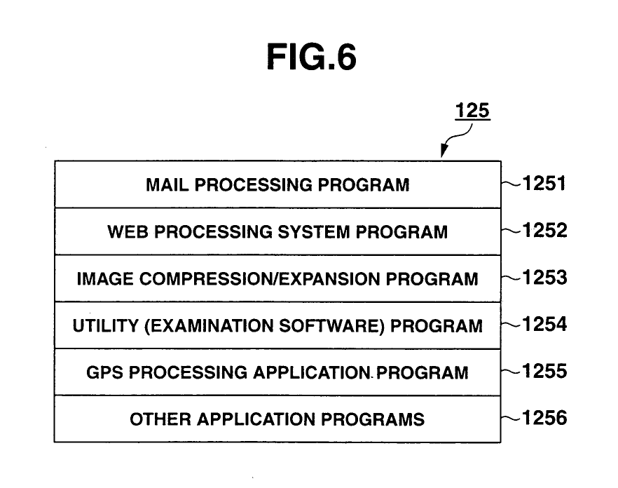

An address data bus processing unit 123 controls and manages the timings of inputting/outputting data, or the like between the control unit 122 and peripheral circuits (circuits within the dashed line frame). A RAM 124 stores various data, such as address book data and mail data, which are generated in the wireless telephone 1. As illustrated in FIG. 6, a program ROM (NAND type flash memory) 125 stores a mail processing program 1251, a Web processing system program 1252 in which a browser is stored, an image compression/expansion program 1253 in accordance with JPEG, MPEG-2, and MPEG-4 systems, a utility (examination software) program 1254, a GPS processing application program 1255, and other application programs 1256. The program RAM 125 selects and loads these programs in the control unit 122 in accordance with operations of the user. A sound source IC 126 stores and outputs a waveform of a notification sound, an amplifier 127 amplifies the output from the sound source IC 126, and the indication speaker 120 reproduces the amplified output.

A display module system driver 128 drives the main display unit 102, sub-display unit 116, indication LED 117, and flashing LED 119. The image pickup device 130 includes a CCD in which an object image is formed by the image pickup lens 118, and the like, and a DSP 129 processes image signals from the image pickup device 130.

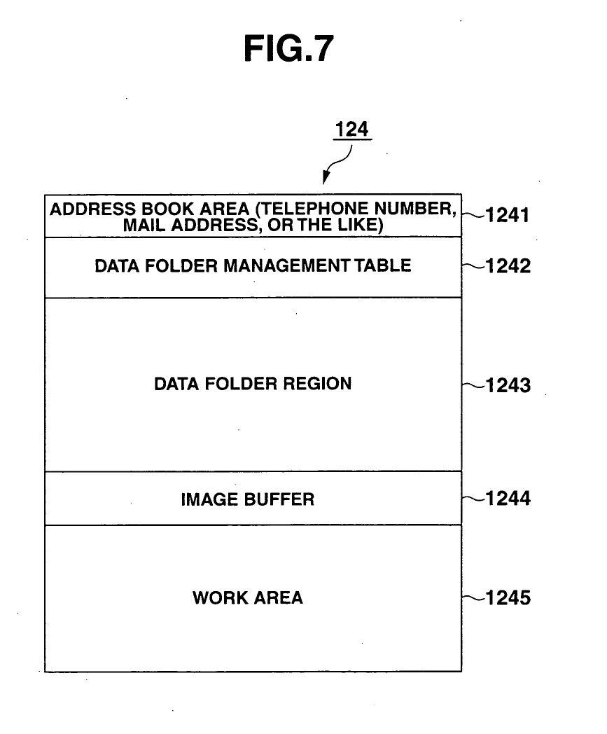

FIG. 7 is a conceptual illustration showing a configuration of a memory area of the RAM 124. The RAM 124 includes an address book area 1241, data folder management table 1242, data folder region 1243, image buffer 1244, and work area 1244. At the address book area 1241, with a name, telephone number, mail address, and the like being made to be as one record, a plurality of records are stored. The data folder management table 1242 is a region at which the corresponding relationship between a photographed image file including the positional information and stored in the data folder region 1243 and the address thereof. The data folder region 1243 is a region at which the image file itself including the positional information is stored. The image buffer 1244 is a region at which photographed image data are temporarily stored. The work area 1244 serving as a work memory stores various data.

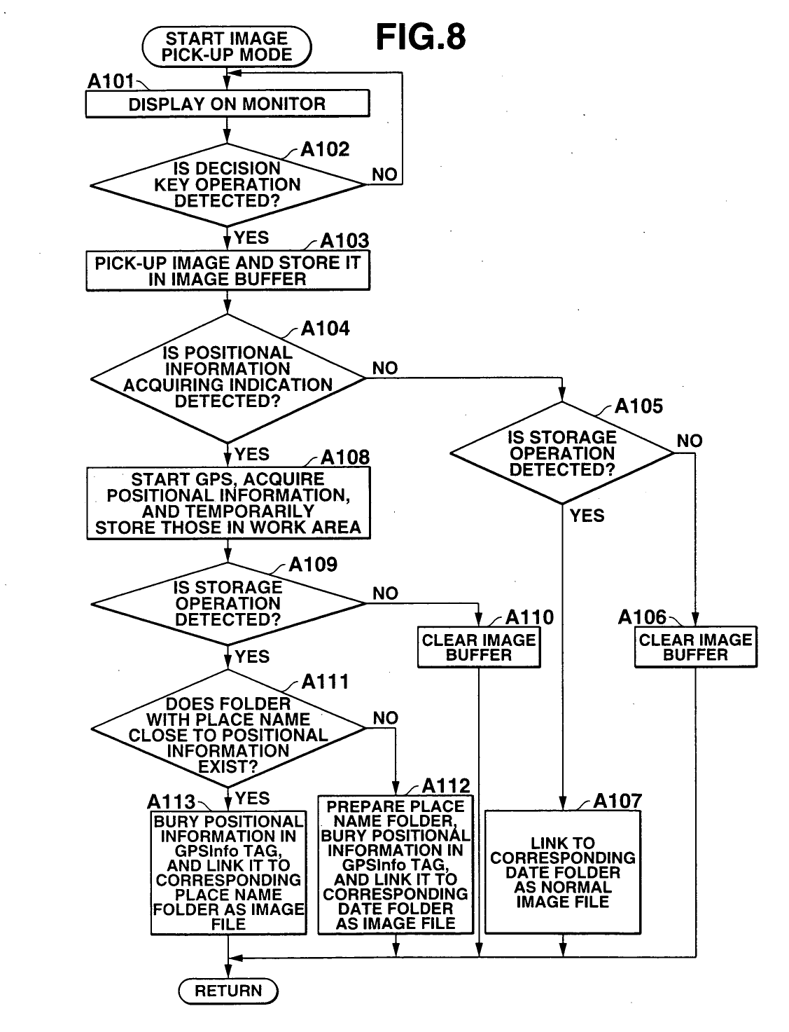

Next, the operations of the present embodiment relating to the above-described configuration will be described. When the user of the wireless telephone 1 sets a photographing mode by an operation of the camera key 104, the control unit 122 executes processings in accordance with the flowchart shown in FIG. 8 by loading the image compression/expansion processing program 1253 stored in the program ROM 125.

First, the control unit 122 carries out monitor display processing, and displays a through image formed on the image pickup device 130 by the image pickup lens 118 on the main display unit 102 (step A101). Next, the control unit 122 determines whether or not an operation of the decision key 107 is detected (step A102), and when it is detected, the control unit 122 fetches the digital image data picked-up by the image pickup device 130 and processed by the DSP 129, and stores the digital image data in the image buffer 1244 (step A103).

Continuously, the control unit 122 determines whether or not a positional information acquiring indication is detected by detecting the operations of the cross key 106 and the decision key 107 (step A104). When a positional information acquiring indication is not detected, the control unit 122 determines whether or not a storage operation is detected (step A105). When a storage operation is not detected, the control unit 122 erases the image data stored in the image buffer 1244 in step A103 (step A106).

When a storage operation is detected, the control unit 122 processes to compress the image data stored in the image buffer 1244 in step A103 as a normal image file, and links the image file to a sub-folder name-1 (date folder) (step A107). The file name of the image file is automatically generated so as to include the information of the date and the number of photographings.

On the other hand, when a positional information acquiring indication is detected in step A104, the control unit 122 loads with the GPS processing application program 1255 and acquires the current positional information (latitude/longitude information) for the positional information arithmetic processing 1225, and then temporarily stores the positional information in the work area 1245 (step A108). Next, the control unit 122 determines whether or not a storage operation is detected (step A109). When a storage operation is not detected, the control unit 122 erases the image data stored in the image buffer 1244 in the same way as the processing in step A106 (step A110).

When a storage operation is detected, the control unit 122 determines whether or not a place name folder having a place name close to the positional information acquired in the previous step A108 exits (step A111). When a similar place name folder does not exist, the control unit 122 newly prepares a place name folder, buries the positional information in a GPSInfo tag of the Exif standard, processes to compress the positional information as a normal image file, links the image file to the sub-folder name-1 (date folder), and stores it in the data folder region 1243 (step A112). At that time as well, the file name of the image file is automatically generated so as to include the information of the date and the number of photographings.

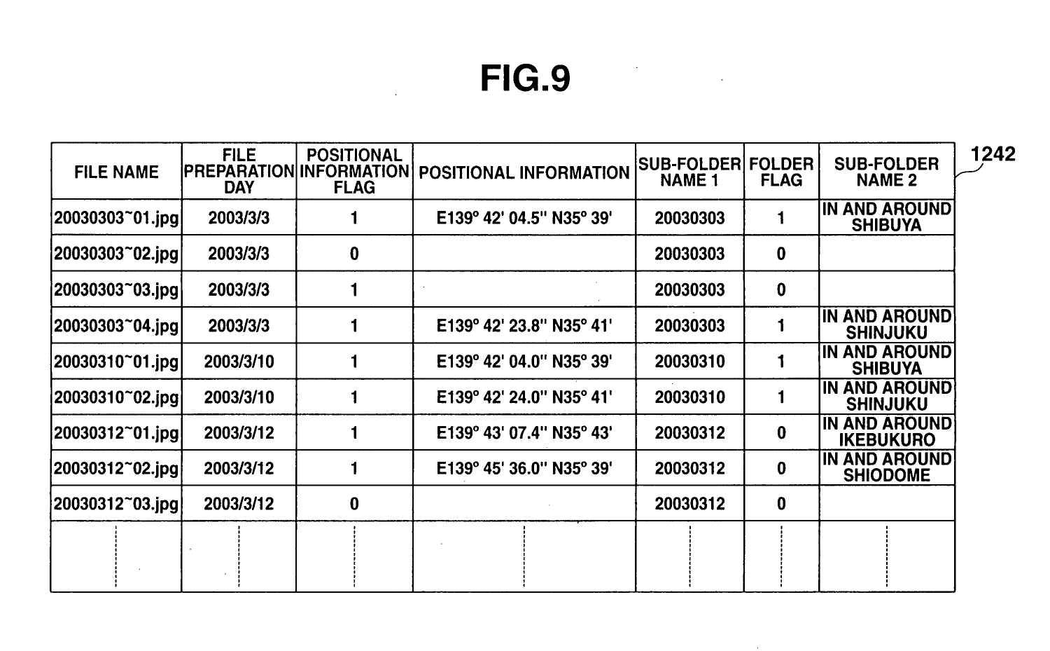

When a place name folder having a place name close to the positional information acquired in the previous step A108 exists, the control unit 122 buries the positional information in a GPSInfo tag of the Exif standard, and links the positional information to a corresponding place name folder (step A113). The data folder management table 1242 at that time uses a storage management method as shown in FIG. 9 in a case of focusing on storage management of the image file. In a case of an image file, a file name, file preparation date, positional information flag, positional information, sub-folder name-1 (date folder), folder flag, and sub-folder name-2 (place name folder) are managed as one record. For example, it will be described with reference to the top table in the management table 1242. With respect to a file name “20030303-01.jpg”, “20030303-01.jpg” is stored at the file name area; “2003/3/3” is stored at the file preparation date area; “1” denoting that positional information is added is stored at the positional information flag area; “E (the east longitude) 139°42′04.5” N (the north latitude) 35°39′” which is the acquired positional information is stored at the positional information area; a date folder “20030303” is stored at the sub-folder name-1 area; “1” denoting that a place name folder is prepared is stored at the folder flag area; and a place name folder “in and around Shibuya” is stored at the sub-folder name-2 area.

For example, if the processings in steps A111 to A113 are applied to a case where the image file of the file name “20030310-01.jpg” is stored in the data folder, at the time of preparing the image file, the positional information acquired in step A108 is “E139°42′04.0” N35°39′”. When the positional information is acquired, the control unit 122 determines whether or not the image file having positional information close to the positional information has been already stored in the data folder management table 1242, and finds the image file “20030303-01.jpg” managed by the similar positional information E139°42′04.5” N35°39′. Then, the control unit 122 associates it with the sub-folder name-2 which is the same as the sub-folder name-2 (place name folder) “in and around Shibuya” of the image file “20030303-01.jpg”.

At this time, “1” is set in the folder flag. Note that the information stored at the file preparation date area and the positional information area are respectively stored in the corresponding tags when the image file corresponds to the Exif standard (the positional information is stored in the “GPSInfo” tag), and at the same time, the information are transferred to and stored in the data folder management table 1242.

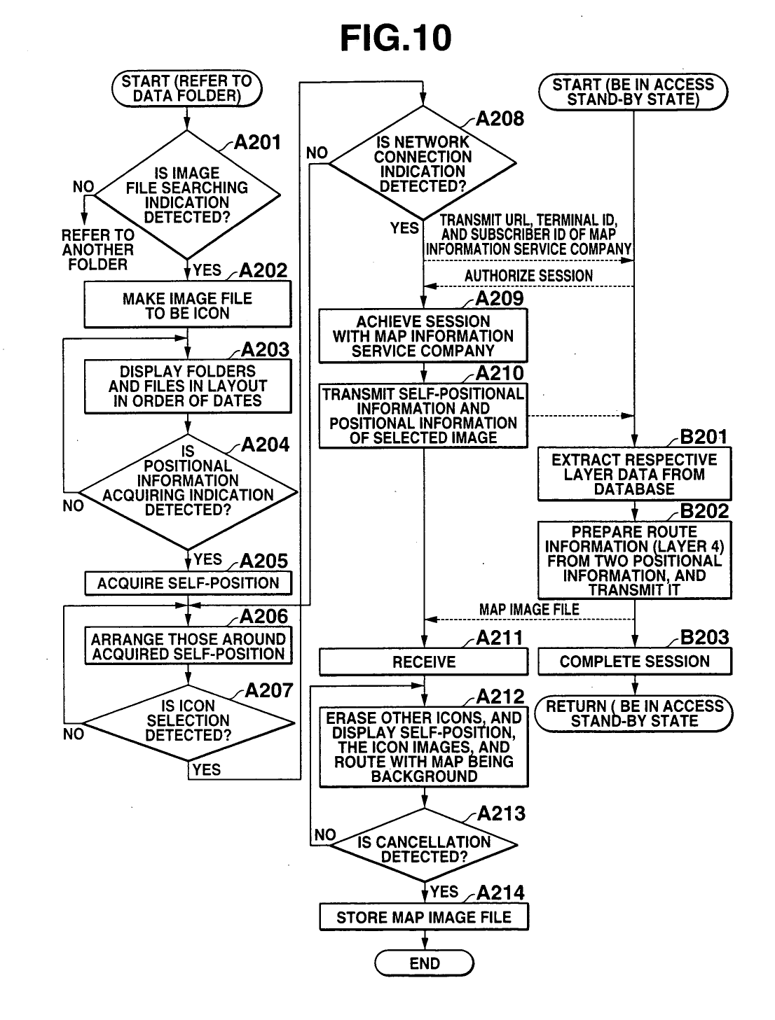

On the other hand, when the wireless telephone 1 is in a stand-by state, when the control unit 122 detects predetermined key operations (the operations of the cross key 106 and the decision key 107) of the user, the utility (examination software) program 1254 stored in the program ROM 125 is loaded, and the control unit 122 executes the processings in accordance with the flowchart shown in FIG. 10.

First, the control unit 122 determines whether or not a searching indication of the image file by the user is detected (step A201). When a searching indication of the image file is detected, the control unit 122 extracts image files from among various files stored in the data folder region 1243 with reference to the data folder management table 1241, and processes to reduce the actual images or the thumbnail images of the extracted image files so as to be icons (step A202). Namely, because the display surface area of the main display unit 102 of the wireless telephone 1 is limited, it is difficult even to display a plurality of images as the thumbnails, and therefore, the image files are made to be icons prior to the displaying.

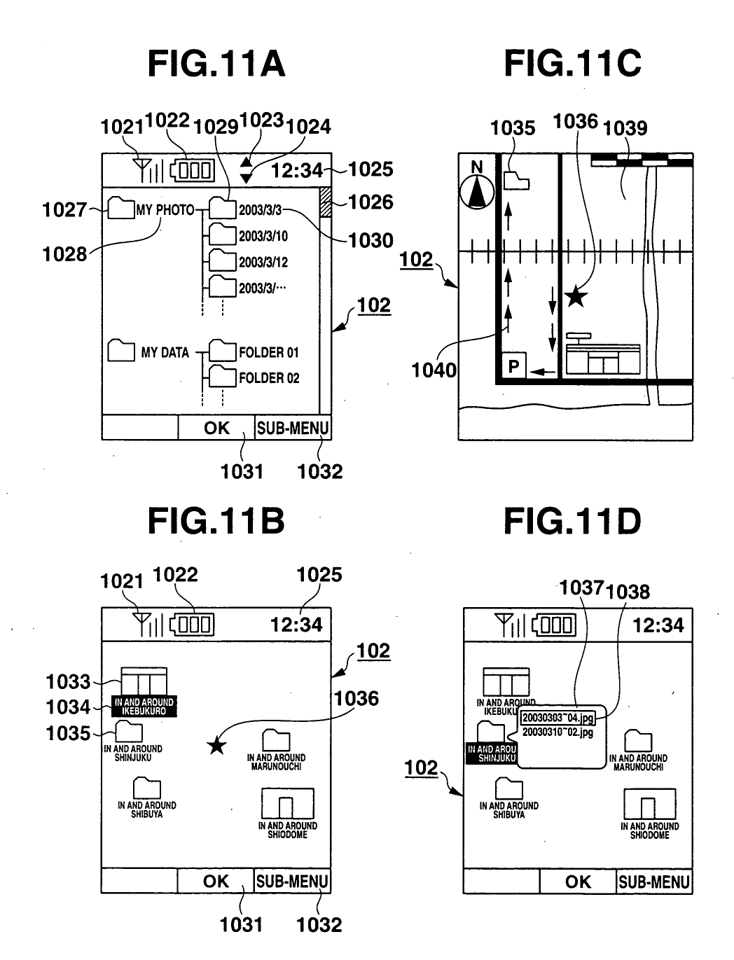

Continuously, the control unit 122 layout-displays these image files on the main display unit 102 in order of the date folders linked to these image files (step A203). By the processing in step A203, as shown in FIG. 11A, a folder icon 1027 of a “My photo” folder for classifying and managing the images photographed by the wireless telephone 1, a folder name 1027 (the folder name is “My photo”), file icons 1029, 1029, . . . , and date file names 1030, 1030, . . . , (2003/3/3, 2003/3/10, . . . ,) corresponding to the file icons are displayed on the main display unit 102. In FIG. 11A, reference numeral 1021 denotes a received field intensity icon, 1022 denotes a buttery residual quantity icon, 1023 denotes an up-scrolling icon (corresponding to an upward operation of the cross key 106), 1024 denotes a down-scrolling icon (corresponding to an downward operation of the cross key 106), 1025 denotes a current time display area, 1026 denotes a scroll bar, 1031 denotes an OK display area (corresponding to an operation of the decision key 107), and 1032 denotes a sub-menu area (corresponding to an operation of the address key 108).

Next, the control unit 122 displays a sub-menu by an operation of the address key 108, and continues this display state (step A203) until the time when a positional information acquiring indication is detected. When the positional information acquiring indication is detected (YES in step A204), the control unit 122 loads the GPS processing application program 1255 and acquires the self-positional information (latitude/longitude information) in the same way as the processing in step A108 (step A205). Moreover, centering on the acquired self-position, the file icons displayed in step A203 are erased, and only the image files to which the positional information are added are left. The control unit 122 reads a place name folder corresponding to the image file, relocates the image file icons and the folder icons, and layout-displays those on the main display unit 102 (step A206).

At that time, on the basis of the relative relationship between the self-position and the respective image file icons and the folder icons, the control unit 122 arranges the image file icons and the folder icons at relative positions with the self-position being as the center thereof and with the top, bottom, left, and right of the display unit 102 being as the north, south, west, and east. Therefore, by the processing in step A206, as shown in FIG. 11B, image file icons 1033, place name folder names (sub-folder name-2) 1034 thereof and folder icons 1035 are displayed around a self-position 1036 on the main display unit 102.

Next, the control unit 122 determines whether or not a selection of one of the image file icons 1033 or the folder icons 1035 is detected by operations of the cross key 106 and the decision key 107 (step A207). When a selection is detected, the control unit 122 determines whether or not a network connection indication by an operation of the net connection key 109 is detected (step A208). When a network connection indication is detected, the control unit 122 accesses to the communication service company 4 via the wireless base station 2, and transmits the URL, the terminal ID, and the subscriber ID of the map information service company 6. The communication service company 4 carries out authentication processing on it, and transmits a session authorization. The wireless telephone 1 receives this session authorization, and achieves a session with the map information service company 6 (step A209).

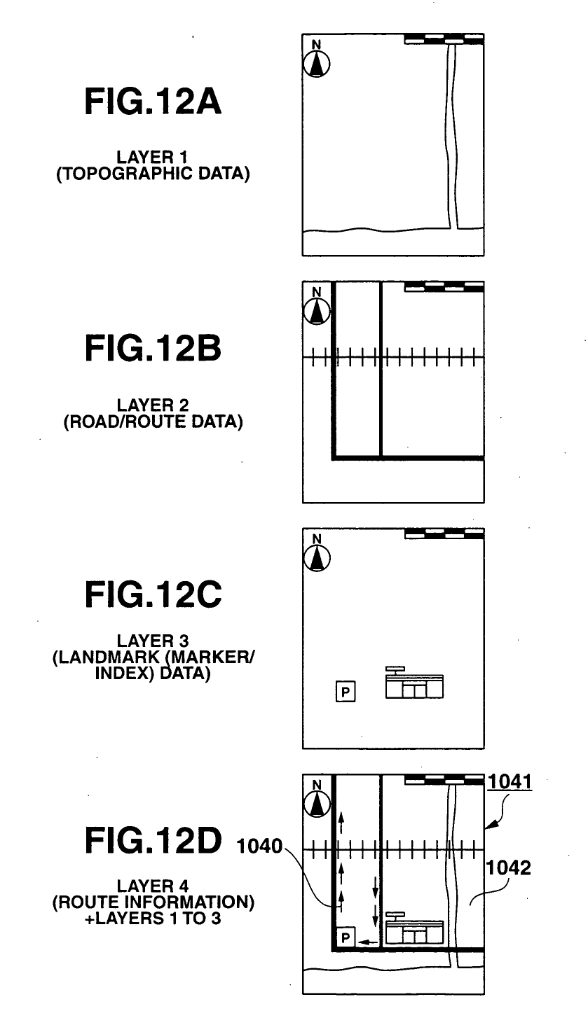

Thereafter, the wireless telephone 1 transmits the self-positional information (current positional information) acquired in step A205 and the positional information which the image file icon 1033 or the folder icon 1035 selected in step A207 includes, to the map information service company 6. Then, the managing server 63 of the map information service company 6 starts processings shown in the flowchart shown in FIG. 10 in the same way, and extracts respective layer data (layer-1, layer-2, and layer-3 data) including the current positional information and the photographing positional information from the map database 62 (step B201). Namely, the managing server 63 extracts the layer-1 data including the current positional information and the photographing positional information as shown in FIG. 12A, and extracts the corresponding layer-2 data (FIG. 12B), and extracts the corresponding layer-3 data (FIG. 12C).

Moreover, the managing server 63 prepares a layer-4 data which is a route from the current position to the photographed position on the basis of the two positional information (the current positional information and the photographing positional information) and the extracted layer-3 data, and transmits the map image file in which the prepared layer-4 data and the layer-1 to layer-3 data are superposed on each other (step B202). Accordingly, by the processing in step B202, as shown in FIG. 12D, a map image file 1041 having the layer-1 to layer-4 due to, for example, the layer-4 data in which the route is shown by advance arrows 1040 being superposed on a map 1042 having the layer-1 to layer-3, and the map image file 1041 is transmitted to the wireless telephone 1. At this time, the file name of the map image file 1041 to be transmitted is determined by “place (prefectures)”, “cities, wards, towns, and villages” of the layer-3 data. For example, if the layer-3 data extracted in step B201 is the data of a map management number “000000”, the file name is “Hokkai-do, Wakkanai-city 1”. Thereafter, the managing server 63 of the map information service company 6 completes the session with the wireless telephone 1, and returns to being in an access stand-by state.

On the other hand, the wireless telephone 1 receives the map image file 1041 having the layer-1 to layer-4 data on which the route is shown by advance arrows 1040 (step A211). The wireless telephone 1 erases image file icons 1033 and folder icons 1035 other than the icon selected in step A207, and displays the self-position, the selected image file icon 1033, the selected folder icon 1035, and the route (step A212). Accordingly, by the processing in step A212, the display state of the main display unit 102 is transferred from FIG. 11B to FIG. 11C, and the other icons (the image file icons 1033 and the folder icons 1035) are erased. Only the selected file icon 1035 is displayed, and the self-position 1036, the folder icon 1035, and the route by the advance arrows 1040 are displayed with a map 1039 being as a background.

Further, until the time when a canceling indication by an operation of the clear key 110 is carried out (step A213), the display state shown in FIG. 11C is continued. Accordingly, the user can easily reach from the current position to the selected position where the photo was taken by moving the routine while monitoring the display of the main display unit 102. Then, when the user carries out a canceling indication when this display is not necessary, the file name of the map image file is stored in the data folder region 1243 so as to correspond to the place name folders of the selected image file icon 1033 and the folder icon (step A214).

Note that, when the file name of the map image file is, for example, “Hokkai-do, Wakkanai-city 1”, the place name folder having this file name “Hokkai-do, Wakkanai-city 1” as a folder name is prepared in the data folder region 1243, and the file icon 1035 and the image file may be associated with one another by being associated with this place name folder.

In this way, in step A111 of FIG. 7 described above, the positional information of the place name folder stored in the data folder region 1243 is compared with the photographing positional information acquired in step A108, whereby it can be determined whether or not a place name folder close to the positional information denoted by the photographing positional information exists. Then, when a place name folder close to the positional information does not exist (NO in step A111), the control unit 122 buries the positional information in the GPSInfo tag, stores the positional information in the data folder management table 1242, and stores it in the data folder region 1243 as an image file (step A112). Therefore, in this case, the image file in which the positional information has been buried in the GPSInfo tag is directly stored in the data folder region 1243 without being passed through the date folder.

Note that, in the present embodiment, the map image file is acquired by detecting an operation of the net connection key 109 in step A208. However, due to the specific folder icons 1035 being selected, an image files associated with the folder icons 1035 may be displayed in a list.

FIG. 11D illustrates the case, and with reference to the data folder management table 1242 of FIG. 9, image files “20030303-04.jpg” and “20030310-02.jpg” are associated with each other in the place name folder “in and around Shinjuku”. Accordingly, at the stage of displaying FIG. 11B, two image files are grouped together in the folder icon 1035 of the place name folder “in and around Shinjuku”.

Here, when an operation of the decision key 107 is detected, the image file icon 1033 corresponding to the inversely displayed place name folder “in and around Ikebukuro” is selected, and the image file “20030312-01.jpg” is read out from the data folder region 1243, so that a corresponding image is displayed. However, when the place name folder “in and around Shinjuku” is selected by detecting an operation of the cross key 106, as shown in FIG. 11D, a balloon 1037 is displayed with respect to the place name folder, and the file names 1038 of the two image files are indicated in the balloon 1037.

Then, in this display state, by detecting upward/downward operations of the cross key 106, a corresponding image file is read out from the data folder region 1243 and displayed.

In step A206, the control unit 122 arranges the image file icons and the folder icons at relative positions with the self-position being as the center thereof and with the top, bottom, left, and right of the display unit 102 being as the north, south, west, and east on the basis of the relative relationship between the self-position and the respective image file icons and the folder icons. However, a heading-up function is provided by detecting the travelling direction, and the respective image file icons and the folder icons may be layout-displayed with the advance direction being as the top side of the display unit.

### MODIFIED EMBODIMENTS

In the above described embodiment, the layout-display of the image files has been described. The present invention is not limited to the method of displaying the image files, and may be applied to the other multifarious files.

In this modified embodiment, descriptions of portions having configurations and functions which are the same as those of the above-described embodiment will be omitted.

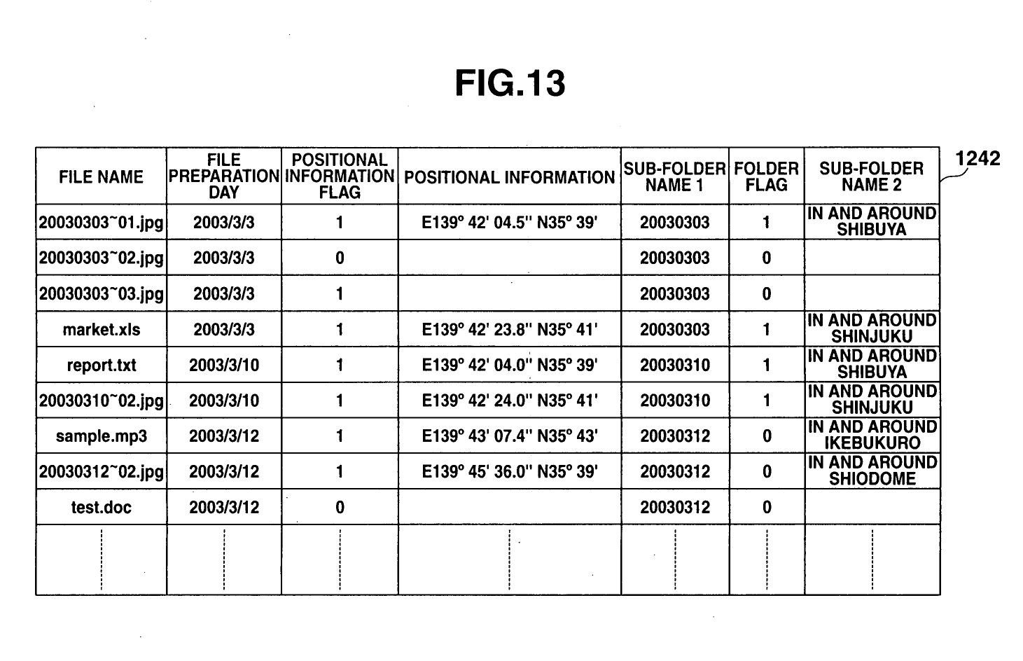

FIG. 13 is a diagram showing the contents of the data folder management table 1242. FIG. 13 is different from FIG. 9 in the point that the image files are not managed, but the positional information are arbitrarily associated with all of the files stored in the data folder region 1243. This may be carried out such that the positional information are added by loading the GPS processing application program 1255 when the files are prepared, or the positional information are added at the timing of detecting the other file operations at the time of editing.

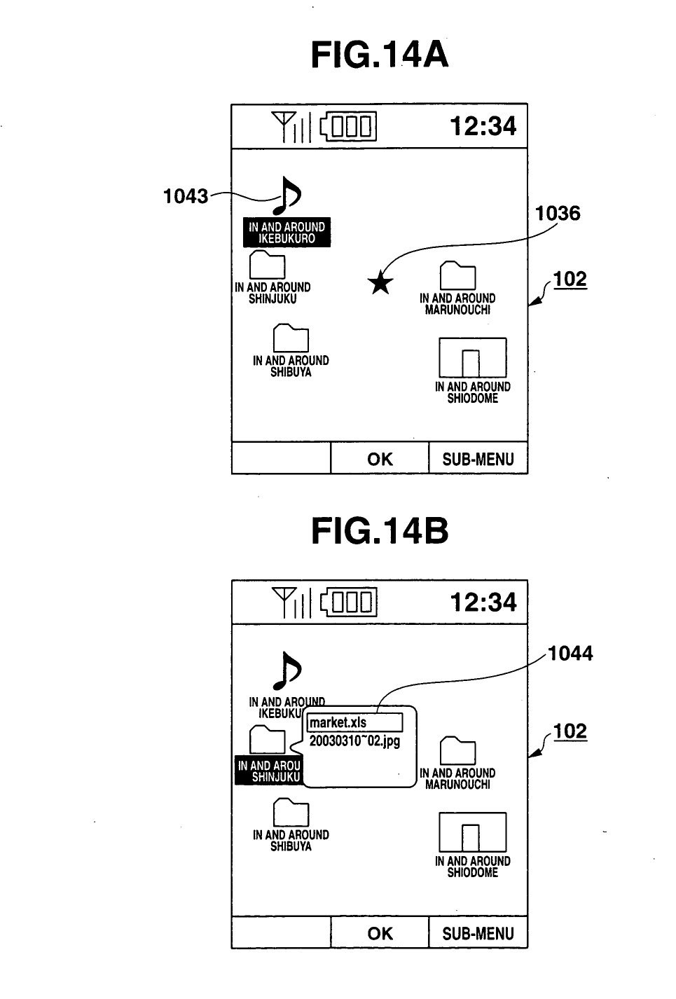

In this way, when the utility (examination software) program is loaded, and the GPS processing application program 1255 is further loaded in the various files having the positional information added thereto, the display mode is as FIG. 14A.

The contents of the layout-display are close to those of FIG. 11B. However, for example, with reference to FIG. 13, because an audio file which is “sample.mp3” is stored in the place name folder “in and around Ikebukuro”, a note icon 1043 is displayed. Further, when the place name folder “in and around Shinjuku” is selected and inversely displayed by detecting an operation of the cross key 106, as shown in FIG. 14B, a balloon is displayed with respect to the place name folder, and the file names 1044 of two files “market.xls” and “20030310˜02.jpg” are displayed in the place name folder.

Then, in this display state, by detecting upward/downward operations of the cross key 106, a corresponding file is read out from the data folder region 1243 and expanded (a corresponding application program is loaded), and displayed.

In this way, in accordance with the embodiments of the present invention, provided that the positional information are associated with the image files and the other various files, the files and folders along the positional information can be layout-displayed. Therefore, when and where what files are operated can be intuitively understood, and in particular, in a case of being active outdoors, the files can be more promptly operated.

Note that, in the embodiments, the image files are made to be icons and displayed. However, when the display surface area of the display unit is sufficient, or the like, the image files are not made to be icons, and may be displayed in appropriate sizes. Further, in the embodiments, the case where the invention is applied to a wireless telephone has been described. However, the invention may be applied to a digital camera or a PDA with a camera or a GPS receiving apparatus with a camera.

Furthermore, in the embodiments, the contents of the image files are displayed on the main display unit 102. However, the contents of the image files may be displayed on the sub-display unit 116 in accordance with a resolution or a display size, and it may be a functional structure such that the route information can be confirmed even in a state in which the cover portion is closed as is.

1. An electronic device comprising:
a storage unit which stores data along with date information of a day when the data is operated;
a storage managing unit which manages the data stored in the storage unit on the basis of the date information;
a first positional information acquiring unit which acquires positional information at the time of operating the data;
a storage control unit which stores the positional information acquired by the first positional information acquiring unit so as to correspond to the operated data in the storage unit;
a display unit;
a first indicating unit which indicates a list-display of the data stored in the storage unit;
a first display control unit which displays the data on the display unit in a layout based on the date information managed by the storage managing unit when the list-display is indicated by the first indicating unit;
a second indicating unit which indicates a list-display based on the positional information of the data stored in the storage unit; and
a second display control unit which displays the data on the display unit in a layout based on the positional information which have been made to correspond to respective data stored in the storage unit when the list-display is indicated by the second indicating unit.

2. An electronic device according to claim 1, further comprising:
a selecting unit which selects whether or not the positional information are made to correspond by the storage control unit, and wherein
the second display control unit displays data for which it is selected that the positional information are made to correspond thereto by the selecting unit on the display unit in a layout based on the positional information acquired by the first positional information acquiring unit.

3. An electronic device according to claim 1, further comprising:
a distance discriminating unit which discriminates between relative distances of the positional information made to correspond to the respective data stored in the storage unit, and wherein
the storage control unit stores data determined to be near to one another by the distance discriminating unit so as to be associated with one another.

4. An electronic device according to claim 3, wherein the second display control unit displays the data which have been stored in the storage unit and associated with one another on the display unit in a layout based on the positional information which have been stored so as to be made to correspond to the data when the list-display is indicated by the second indicating unit.

5. An electronic device according to claim 1, further comprising:
a second positional information acquiring unit which acquires current positional information of the device, and wherein
the second display control unit further displays the data in a layout based on the positional information acquired by the second positional information acquiring unit.

6. An electronic device according to claim 5, further comprising:
a data selecting unit which selects specific data from a state of the layout-display by the second display control unit;
a positional information transmitting unit which transmits positional information corresponding to the data selected by the data selecting unit and the positional information acquired by the second positional information acquiring unit to a map database existing on a network outside the device;
a map data receiving unit which receives map data from the map database in response to the positional information transmitted by the positional information transmitting unit; and
a third display control unit which displays the selected data and the current positional information on the display unit in a layout including the map data received by the map data receiving unit.

7. An electronic device according to claim 6, wherein the map data includes route data which connects the selected data and the current positional information.

8. An electronic device according to claim 7, further comprising:
an image pickup unit;
a generating unit which generates image data by operating picked-up images by the image pickup unit, and wherein
the first positional information acquiring unit acquires positional information when the image data is generated by the generating unit.

9. An information display method for an electronic device having a positional information acquiring unit, the method comprising:
a first storage step of storing and managing data on the basis of date information of a day when the data is operated;
a first positional information acquiring step of acquiring positional information by the positional information acquiring unit when the data is operated;
a second storage step of storing the positional information acquired in the first positional information acquiring step so as to be made to correspond to the operated data;
a first indicating step of indicating a list-display of data stored in a memory;
a first display control step of displaying the data in a layout based on the date information stored in the first storage step when the list-display is indicated by the first indicating step;
a second indicating step of indicating a list-display based on the positional information of the data stored in the memory; and
a second display control step of displaying the various data in a layout based on the positional information which have been made to correspond to the respective data stored in the memory when the list-display is indicated by the second indicating step.

10. An information display method according to claim 9, further comprising:
a selecting step of selecting whether or not the positional information is made to correspond by the storage control step, and wherein
the second display control step displays data for which it is selected that the positional information is made to correspond thereto in the selecting step in a layout based on the positional information acquired in the first positional information acquiring step.

11. An information display method according to claim 9, further comprising:
a distance discriminating step of discriminating between relative distances of the positional information which have been made to correspond to the respective data stored in the memory, and wherein
the second storage step stores data determined to be near to one another in the distance discriminating step in the memory so as to be associated with one another.

12. An information display method according to claim 11, wherein the second display control step displays the data which have been stored in the memory and associated with one another in a state of being grouped together in a layout based on the positional information which have been stored so as to be made to correspond to the data when the list-display is indicated at the second indicating step.

13. An information display method according to claim 9, further comprising:
a second positional information acquiring step of acquiring current positional information of the device, and wherein
the second display control step further displays the data in a layout based on the positional information acquired in the second positional information acquiring step.

14. An information display method according to claim 13, further comprising:
a data selecting step of selecting specific data from a state of the layout-display by the second display control step;
a positional information transmitting step of transmitting positional information corresponding to the data selected in the data selecting step and the positional information acquired in the second positional information acquiring step to a map database existing on a network outside the device;
a map data receiving step of receiving map data from the map database in response to the positional information transmitted in the positional information transmitting step; and
a third display control step of displaying the selected data and the current positional information in a layout including the map data received in the map data receiving step.

15. An information display method according to claim 14, wherein the map data includes route data which connects the selected data and the current positional information.

16. An information display method according to claim 15, wherein the electric device comprises an image pickup unit, the information display method further comprising:
a generating step of generating image data by operating picked-up images picked-up at the image pickup unit; and wherein
the first positional information acquiring step, acquires positional information when the image data is generated in the generating step.

17. An information display program which causes a computer of an electronic device comprising a positional information acquiring unit to execute:
a first storage function of storing and managing data on the basis of date information of a day when the data is operated;
a first positional information acquiring function of acquiring positional information by the positional information acquiring unit when the data is operated;
a second storage function of storing the positional information acquired in the first positional information acquiring step so as to be made to correspond to the operated data;
a first indicating function of indicating a list-display of data stored in a memory;
a first display control function of displaying the data in a layout based on the date information stored in the first storage step when the list-display is indicated by the first indicating step;
a second indicating function of indicating a list-display based on the positional information of the data stored in the memory; and
a second display control function of displaying the various data in a layout based on the positional information which have been made to correspond to the respective data stored in the memory when the list-display is indicated by the second indicating step.

18. An information display program according to claim 17, further causing the computer to execute:
a distance discriminating function of discriminating between relative distances of the positional information which have been made to correspond to the respective data stored in the memory, and wherein
the second storage function stores data determined to be near to one another in the distance discriminating step in the memory so as to be associated with one another.

19. An information display program according to claim 17, wherein the second display control function displays the data which have been stored in the memory and associated with one another in a state of being grouped together in a layout based on the positional information which have been stored so as to be made to correspond to the data when the list-display is indicated at the second indicating function.

20. An information display program according to claim 17, wherein the electric device comprises an image pickup unit, the information display program further causing the computer to execute:
a generating function of generating image data by operating picked-up images picked-up by the image pickup unit; and wherein
the first positional information acquiring function acquires positional information when the image data are generated by the generating function.

21. An electronic device comprising:
means for storing data along with date information of a day when the data is operated;
storage managing means for managing the data stored in the storing means on the basis of the date information;
means for acquiring positional information at the time of operating the data;
storage control means for storing the positional information acquired by the first positional information acquiring means so as to correspond to the operated data in the storing means;
means for displaying;
first indicating means for indicating a list-display of the data stored in the storing means;
first display control means for displaying the data on the displaying means in a layout based on the date information managed by the storage managing means when the list-display is indicated by the first indicating means;
second indicating means for indicating a list-display based on the positional information of the data stored in the storing means; and
second display control means for displaying the data on the displaying means in a layout based on the positional information which have been made to correspond to respective data stored in the storing means when the list-display is indicated by the second indicating means.
